(19) United States
(12) Patent Application Publication
(10) Pub. No.: US 2004/0036664 A1
(43) Pub. Date: Feb. 26, 2004

(54) Electronic device, method of driving electronic device, and electronic apparatus

(75) Inventor: Takashi Miyazawa, Suwa-shi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 10/456,574

(22) Filed: Jun. 9, 2003

(30) Foreign Application Priority Data
Jun. 12, 2002 (JP) 2002-171891
Jun. 5, 2003 (JP) 2003-161085

(51) Int. Cl. G09G 3/30

(52) U.S. Cl. 345/76

(57) ABSTRACT

To provide an electronic device which can reduce loads of circuits for supplying data to data lines. Pixel circuits 20 are disposed corresponding to intersections of scanning lines Yn and each of data lines Xm, and each of the corresponding scanning lines is selected to apply data signals or reset control signals through corresponding data lines. A scanning line driving circuit 13 outputs scan signals for selecting the scanning lines other than the scanning lines adjacent to the scanning line selected before at least one line based on address signals ADn when the scanning lines are selected in order to apply the data signals or the reset control signals through the data lines.

### BACKGROUND OF THE INVENTION

1. Field of Invention

The present invention relates to an electronic device, a method of driving an electronic device, and an electronic apparatus.

2. Description of Related Art

Recently, electro-optical apparatuses using organic EL elements have attracted attention. The organic EL elements are spontaneous light emitting elements which do not need a backlight, they are expected to realize display apparatuses with low power consumption, large viewing angle, and high contrast ratio.

The electro-optical apparatus comprises a data line driving circuit for supplying to each of pixel circuits data signals in accordance with the luminance gradation of the organic EL elements. The data line driving circuit is connected to a controller for outputting image data. The data line driving circuit comprises a plurality of single line drivers connected to each of the pixel circuits through data lines. Each of the single line drivers generates a data signal in accordance with the image data output from the controller and supplies the generated data signals to the pixel circuits. The pixel circuits apply driving currents to the organic EL elements in order to control the luminance gradation of the organic EL elements in accordance with the data signals (for example, refer to patent document 1).

[Patent Document 1]

Pamphlet of International Unexamined Application Publication No. WO98/36407.

### SUMMARY OF THE INVENTION

The electro-optical devices having electro-optical elements such as organic EL elements, liquid crystal elements, electrophoresis elements or electron emitting elements, there are problems in that operation delay due to parasite capacitance as the apparatus are having larger size and more accuracy. In particular, the problems are very remarkable in the case that the electro-optical apparatus employs the method of supplying data currents as data signals. In other words, there are some cases that the data current applied to each of the pixel circuits is not applied in a good accuracy due to some wire capacitance of the data lines. As a result, since the writing operation on the data current in the pixel circuit is delayed, it is impossible to obtain accurate gradation of the electro-optical apparatus.

In addition, there are some cases that sufficient display quality of moving picture is not obtained if the states of the pixel circuit are held up to the next data writing.

The present invention has been mainly made in order to solve the aforementioned problems.

The first electronic device according to the present invention is characterized in that the device comprises a plurality of unit circuits disposed corresponding to intersections of a plurality of scanning lines and a plurality of data lines, each unit circuit comprising electronic elements; and a control circuit for generating reset control signals to carry out reset operations of resetting to predetermined states the electronic elements which are included in at least one unit circuit among the plurality of unit circuits, wherein output of the data signals to the plurality of data lines and the reset operations are alternately carried out.

In the electronic device, since outputs of the data signals to the plurality of data lines and the reset operations are alternately carried out, it is possible to use the time intervals for the reset operations as time intervals for preparing data signals next applied to the plurality of data lines.

For example, describing the case that display of the electro-optical apparatus having electro-optical elements such as liquid crystal elements as electronic elements by using the data signals, if the non-display time intervals are prepared by the reset operations, the so called impulse operation can be carried out, so that it is possible to enhance the display quality of the moving picture, particularly.

In addition, “reset control signal” in the present invention is a control signal for resetting the electronic element to a predetermined state, but it is not particularly limited, and for example, it may be a signal for having direct function on the electronic element itself or it may be a signal for having indirect function on the electronic element by having direct function on an active element for controlling the electronic element.

The second electronic device according to the present invention is characterized in that the device comprises a plurality of unit circuits disposed corresponding to intersections of a plurality of scanning lines and a plurality of data lines, each unit circuit comprising electronic elements, data signals and reset control signals for resetting the electronic elements to predetermined states being supplied to the plurality of unit circuits; and a scanning line driving circuit for selecting a scanning line from the plurality of scanning lines in accordance with the supplied data signals, wherein the scanning line driving circuit supplies scanning signal to the plurality of scanning lines so that a first scanning line which is selected from the plurality of scanning lines in order to apply a data signal to a first unit circuit among the plurality of unit circuits is not adjacent to a second scanning line which is selected from the plurality of scanning lines in order to subsequently supply the data signal to a second unit circuit among the plurality of unit circuits other than the first unit circuit; and wherein during the time interval from the time that the data signal is supplied to the first unit circuit to the time that the data signal is supplied to the second unit circuit, the reset control signal is supplied to a third unit circuit other than the first unit circuit and the second unit circuit.

In addition, in the aforementioned electronic device, it is preferable that a third scanning line corresponding to the third unit circuit among the plurality of scanning lines be adjacent to the first scanning line and the second scanning line.

In the aforementioned electronic device, since the scanning line driving circuit supplies scanning signal to the plurality of scanning lines so that a first scanning line which is selected from the plurality of scanning lines in order to apply a data signal to a first unit circuit among the plurality of unit circuits is not adjacent to a second scanning line which is selected from the plurality of scanning lines in order to subsequently supply the data signal to a second unit circuit among the plurality of unit circuits other than the first unit circuit, for example in the case that the electronic device is used as a display apparatus, the positions applied by the data signals can be spatially distributed, so that it is possible to enhance visibility as a display apparatus. In addition, if the reset control signal is used at the time of non-display, it is possible to enhance visibility at the time of displaying moving pictures, as described above. Furthermore, it is possible to use the time interval for supplying the reset control signals as a preparation time interval of the data signal next applied.

The third electronic device according to the present invention is characterized in that the device comprises a plurality of unit circuits disposed corresponding to intersections of a plurality of scanning lines and a plurality of data lines, each unit circuit comprising electronic elements, data signals and reset control signals for resetting the electronic elements to predetermined states being supplied to the plurality of unit circuits; and a scanning line driving circuit for selecting a scanning line among the plurality of scanning lines in accordance with the supplied data signals, wherein the scanning line driving circuit supplies scanning signal to the plurality of scanning lines so that a first scanning line which is selected from the plurality of scanning lines in order to apply a data signal to a first unit circuit among the plurality of unit circuits is adjacent to a second scanning line which is selected from the plurality of scanning lines in order to subsequently supply the data signal to a second unit circuit among the plurality of unit circuits other than the first unit circuit; and wherein during the time interval from the time that the data signal is supplied to the first unit circuit to the time that the data signal is supplied to the second unit circuit, the reset control signal is supplied to a third unit circuit other than the first unit circuit and the second unit circuit.

In addition, in the aforementioned electronic device, it is preferable that a third scanning line corresponding to the third unit circuit among the plurality of scanning lines be not adjacent to the first scanning line and the second scanning line.

In the aforementioned electronic device, since applications of the data signals and the reset operations are alternately carried out, it is possible to reduce circuit loads of the data line driving circuit due to generation or application of the data signals. In addition, it is possible to use the time interval for supplying the reset control signals as a preparation time interval of the data signal next applied. Furthermore, if the reset control signals are used to set non-display time intervals in a display apparatus, black display is carried out between the applications of the data signals, so that it is possible to enhance visibility at the time of displaying moving pictures.

The fourth electronic device according to the present invention is characterized in that the device comprises a plurality of unit circuits disposed corresponding to intersections of a plurality of scanning lines and a plurality of data lines, each unit circuit comprising electronic elements, data signals and reset control signals for resetting the electronic elements to predetermined states being supplied to the plurality of unit circuits; and a scanning line driving circuit for selecting a scanning lines from the plurality of scanning lines in accordance with the supplied data signals, wherein the scanning line driving circuit alternately selects scanning lines for supplying the data signals thereto and scanning lines for supplying the reset control signals thereto.

In the aforementioned electronic device, since the data line driving circuit alternately selects scanning lines for supplying the data signals thereto and the scanning lines for supplying the reset control signals thereto, it is possible to use the time interval for supplying the reset control signals as a preparation time interval for the next data signals. In addition, if the reset control signals are used as non-display signals in the case that the electronic device is used as a display apparatus, black display is carried out between the applications of the data signals, so that it is possible to enhance visibility at the time of displaying moving pictures, as described above.

The fifth electronic device according to the present invention is characterized in that the apparatus comprises a plurality of unit circuits disposed corresponding to intersections of a plurality of scanning lines and a plurality of data lines, each unit circuit comprising a first transistor which is controlled by a scan signal applied through the corresponding scanning line among the plurality of scanning lines, a storage element for holding a data signal supplied through the first transistor, a second transistor whose conduction state is set in accordance with the data signal held in the storage element, and electronic elements having applied thereto voltages or currents having voltage levels or current levels in accordance with the conduction state of the set second transistor; a data line driving circuit for outputting the data signals to the plurality of data lines; and a scanning line driving circuit for supplying the scan signals to the plurality of unit circuits, wherein during the time interval from the time that the data signal is supplied to a first unit circuit among the plurality of unit circuits to the time that the data signal is supplied to a second unit circuit other than the first unit circuit, a reset control signal for substantially turning off the second transistor in the storage element is supplied to a third unit circuit other than the first unit circuit and the second unit circuit through the corresponding data line among the plurality of data lines.

In the electronic device, since the reset control signals are applied through the data lines, the reset of the unit circuits and the charge reset involved in the data lines can be simultaneously carried out, it is possible to carry out the writing of the next data in a high speed.

In addition, it is preferable that a memory device comprising a semiconductor device such as SRAM besides capacitor device be used as the storage element.

In the aforementioned electronic device, it is preferable that the first scanning line, of the plurality of scanning lines, corresponding to the first unit circuit be adjacent to the second scanning line, of the plurality of scanning lines, corresponding to the second unit circuit, and a third scanning line of the plurality of scanning lines corresponding to the third unit circuit is not adjacent to the first scanning line and the second scanning line.

In the aforementioned electronic device, it is preferable that the first scanning line, of the plurality of scanning lines, corresponding to the first unit circuit be adjacent to the third scanning line, of the plurality of scanning lines, corresponding to the third unit circuit, and the second scanning line, of the plurality of scanning lines, corresponding to the second unit circuit is not adjacent to the first scanning line, of the plurality of scanning lines, corresponding to the first unit circuit.

In the aforementioned electronic device, it is preferable that when the reset control signal is supplied to the third unit circuit, the third scanning line be selected and the reset control signal be supplied to the storage element through the first transistor of the third unit circuit.

In the aforementioned electronic device, it is preferable that the data signals be multi-valued.

In the aforementioned electronic device, it is preferable that current signals be applied as the data signals.

In the aforementioned electronic device, it is preferable that the electronic elements be various electro-optical elements such as, for example, LEDs, FEDs, inorganic EL elements, liquid crystal elements, electron emitting elements, or plasma light emitting elements. For example, in case of the EL element, it is preferable that the light emitting layer be constructed with organic materials.

In addition, it is preferable that in all of the aforementioned electronic device, the application of the data signals and the reset operation be alternately carried out, but it is preferable that the reset operation be carried out after consecutively supplying the data signals to the unit circuits corresponding to the several scanning lines among the plurality of scanning lines. In short, it is preferable that at least one reset operation be carried out before supplying the data signals to the plurality of unit circuits corresponding to all the plurality of scanning lines.

The first method of driving an electronic device is characterized to be a method of driving an electronic device comprising a plurality of unit circuits disposed corresponding to intersections of a plurality of scanning lines and a plurality of data lines, each unit circuit comprising electronic elements, the method comprising the steps of: supplying data signal to a first unit circuit among the plurality of unit circuits through the corresponding data line among the plurality of data lines, supplying reset control signals for resetting to predetermined states the electronic elements which are included in a third unit circuit other than the first unit circuit and the second unit circuit among the plurality of unit circuits, and supplying a data signal to a second unit circuit other than the first unit circuit among the plurality of unit circuits through the corresponding data line among the plurality of data lines.

In the aforementioned method of driving an electronic device, it is preferable that scanning lines which are selected from the plurality of scanning lines in order to apply the data signal to the first unit circuit be adjacent to the scanning line corresponding to the third unit circuit among the plurality of scanning lines.

The second method of driving an electronic device is characterized to be a method of driving an electronic device comprising a plurality of unit circuits disposed corresponding to intersections of a plurality of scanning lines and a plurality of data lines, each unit circuit comprising electronic elements, the method comprising the steps of: selecting one scanning line from the plurality of scanning lines in order to supply a data signal to a first unit circuit among the plurality of unit circuits; selecting a scanning line which is not adjacent to the one scanning line which is selected to supply the data signal to the first unit circuit in order to supply the data signal to a second unit circuit other than the first unit circuit; and supplying reset control signal to a third unit circuit other than the first unit circuit and the second unit circuit in order to reset the electronic elements which are included in the third unit circuit during the time interval from the time that the data signal is applied to the first unit circuit to the time that the data signal is applied to the second unit circuit.

The third method of driving an electronic device is characterized to be a method of driving an electronic device comprising a plurality of unit circuits disposed corresponding to intersections of a plurality of scanning lines and a plurality of data lines, each unit circuit comprising electronic elements, the method comprising the steps of: selecting one scanning line from the plurality of scanning lines, and supplying the data signals from the corresponding data lines to each of the unit circuits corresponding to the selected scanning lines; and supplying reset control signals to unit circuits which are disposed to correspond to at least one scanning line among scanning lines other than the scanning lines adjacent to the selected scanning line in order to reset the electronic elements which are included in the unit circuits to predetermined states.

The fourth method of driving an electronic device is characterized to be a method of driving an electronic device comprising a plurality of unit circuits disposed corresponding to intersections of a plurality of scanning lines and a plurality of data lines, each unit circuit comprising electronic elements, the method comprising the steps of: selecting one scanning line from the plurality of scanning lines, and supplying data signals from the corresponding data lines to each of the unit circuits corresponding to the selected scanning lines; and selecting at least one scanning line among scanning lines which are different from the selected scanning line, and supplying reset control signals to unit circuits corresponding to the at least one selected scanning line through corresponding data lines of the plurality of data lines in order to reset the electronic elements to predetermined states.

In the method of driving an electronic device, since the reset control signals are applied through the data lines, the reset of the charges involved in the data lines can be carried out, so that the writing of the next data signals can be advantageously carried out.

The fifth method of driving an electronic device is characterized to be a method of driving an electronic device comprising a plurality of unit circuits disposed corresponding to intersections of a plurality of scanning lines and a plurality of data lines, each unit circuit comprising electronic elements, the method comprising a step of: supplying, during the time interval from the time that writing of data signal to the unit circuit starts to the time that subsequent writing of data signal to the unit circuit starts, reset control signals to at least one unit circuit other than the unit circuit among the plurality of unit circuits in order to reset the electronic elements to predetermined states.

The fifth method of driving an electronic device is characterized to be a method of driving an electronic device comprising a plurality of unit circuits disposed corresponding to intersections of a plurality of scanning lines and a plurality of data lines, each unit circuit comprising electronic elements, the method comprising a step of: supplying reset control signals to at least one unit circuit other than the unit circuits among the plurality of unit circuits in order to reset the electronic elements to predetermined states during the time interval from the time that writing of data signals to the unit circuits starts to the time that subsequent writing of data signals to the unit circuits starts.

In the method of driving an electronic device, if the time interval from the time that a writing of a data signal in a unit circuit starts to the time that a next writing of a data signal in a unit circuit starts is defined as an one frame, a reset operation is carried out over any one unit circuit within the one frame, so that it is possible to use the time interval in which the reset operation by the reset control signal is carried out as a preparation time for generating or supplying a next data signal. By doing so, it is possible to reduce loads of the data line driving circuit for driving data lines or a circuit for supplying reset control signals.

In addition, in all the aforementioned method of driving an electronic device, since at least one reset operation is carried out, and more preferably alternately with the application of the data signals, before supplying the data signals to the plurality of unit circuits corresponding to all the plurality of scanning lines, it is possible to reduce loads of circuits such as the data line driving circuit involved in the generation or application of the data signals in comparison to the case that the reset operation is carried out after selections of all the plurality of scanning lines are completed.

In the aforementioned method of driving an electronic device, it is preferable that multi-valued or analog signals be applied as the data signals.

In the aforementioned method of driving an electronic device, it is preferable that current signals be applied as the data signals.

In the aforementioned method of driving an electronic device, it is preferable that the electronic elements be EL elements.

In the aforementioned method of driving an electronic device, it is preferable that each of the plurality of unit circuits comprise a first transistor which is controlled by a scan signal applied through the corresponding scanning line among the plurality of scanning lines; a storage element for holding the data signals and the reset control signal applied through the first transistor as an electrical quantity corresponding thereto; and a second transistor whose conduction state is set in accordance with the electrical quantity held in the storage element, and the reset control signal is applied the storage element to substantially turn off the conduction state of the second transistor, thereby stopping supplying voltage or current to the electronic elements.

The aforementioned electronic devices are mounted in electronic apparatus according to the present invention.

### BRIEF DESCRIPTION OF THE DRAWINGS

FIG. 1 is a block circuit diagram illustrating the circuit construction of an organic EL display for describing an embodiment according to the present invention.

FIG. 2 is a circuit diagram for describing the internal circuit construction of a display panel portion.

FIG. 3 is a circuit diagram for describing the internal circuit construction of a pixel circuit and a data line driving circuit.

FIG. 4 is a timing chart for describing timings of write operation and reset operation of data signals.

FIG. 5 is a timing chart for describing timings of write operation and reset operation of data signals.

FIG. 6 is a circuit diagram for describing the internal circuit construction of a pixel circuit and a data line driving circuit.

FIG. 7 is a circuit diagram for describing the internal circuit construction of a pixel circuit and a data line driving circuit.

FIG. 8 is a block circuit diagram illustrating the circuit construction of an organic EL display for describing an embodiment according to the present invention.

FIG. 9 is a circuit diagram for describing the internal circuit construction of a display panel portion.

FIG. 10 is a circuit diagram for describing the internal circuit construction of a pixel circuit and a data line driving circuit.

FIG. 11 is a circuit diagram for describing the internal circuit construction of a pixel circuit and a data line driving circuit.

FIG. 12 is a timing chart for comparing to an embodiment according to the present invention.

FIG. 13 is a perspective view illustrating the construction of a portable type personal computer.

FIG. 14 is a perspective view illustrating the construction of a mobile phone.

### DETAILED DESCRIPTION OF PREFERRED EMBODIMENTS

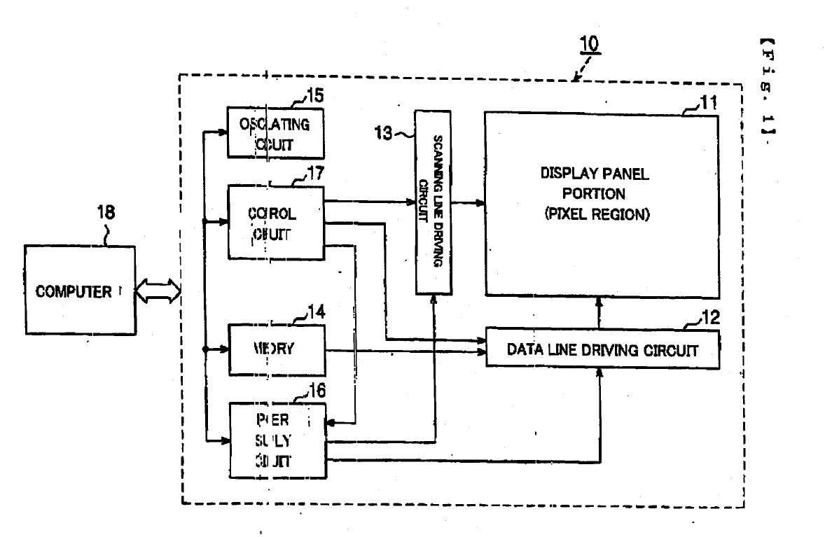

Now, a first embodiment implementing the present invention will be described with reference to FIGS. 1 to 4.

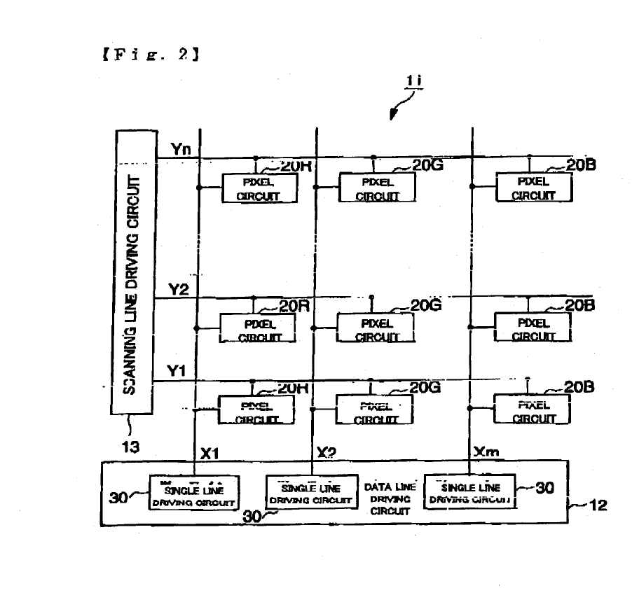

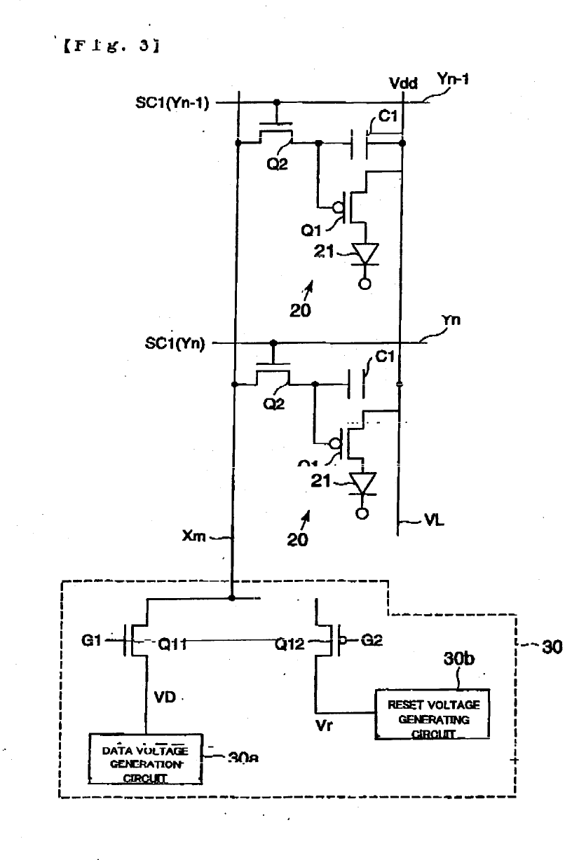

FIG. 1 shows a block circuit diagram showing the circuit construction of an organic EL display 10 as an electronic device. FIG. 2 shows a block circuit diagram showing the internal circuit construction of a display panel portion and data line driving circuit. FIG. 3 shows a circuit diagram showing the internal circuit construction of a pixel circuit.

In FIG. 1, the organic EL display 10 comprises a display panel portion 11, a data line driving circuit 12, a scanning line driving circuit 13, a memory 14, an oscillating circuit 15, a power supply circuit 16, and a control circuit 17.

Each of the components 11 to 17 of the organic EL display 10 may be constructed with independent electronic parts, respectively. For example, each of the components 12 to 17 may be constructed with semiconductor integrated circuit device with one chip. In addition, all or some of the components 11 to 17 may be constructed as an integrated electronic part. For example, the data line driving circuit 12 and the scanning line driving circuit 13 may be integrated in the display panel portion 11. All or some of the components 11 to 16 may be constructed with a programmable IC chip, and thus their functions may be implemented in a software manner by programs which are written in the IC chip.

As shown in FIG. 2, the display panel portion 11 comprises pixel circuits 20 which are a plurality of unit circuits or electronic circuits disposed at positions corresponding to intersections of data lines Xm (m is an natural number) and a plurality of scanning lines Yn (n is an natural number) which extend along the row direction. In other wards, the pixel circuits 20 are connected between the data lines Xm extending along the column direction and the scanning lines Yn extending along the row direction, so that pixel circuits 20 are aligned in a matrix. The organic EL elements 21 as electronic elements or current driving elements are provided in the pixel circuit 20. The organic EL elements 21 are light emitting elements for emitting light by supplying the driving currents.

In the present embodiment, the pixel circuits 20 includes three types of pixel circuits of red, green and blue pixel circuits 20R, 20G, and 20B. The red pixel circuits 20R comprise the organic EL elements 21 for emitting red light from light emitting layers made of organic materials. The green pixel circuits 20G comprise the organic EL elements 21 for emitting green light from light emitting layers made of organic materials. The blue pixel circuits 20B comprise the organic EL elements 21 for emitting blue light from light emitting layers made of organic materials.

The red pixel circuits 20R, the green pixel circuits 20G and the blue pixel circuits 20B are repeatedly aligned in the sequence. Therefore, the red, green and blue pixel circuits 20R, 20G, and 20B aligned in such a manner are connected between the data lines Xm disposed along the column direction and the scanning lines Yn extending along the row direction.

The data line driving circuit 12 comprises single line driving circuits 30 corresponding to each of the data lines Xm. Each of the single line driving circuits 30 supply the data signals to the corresponding red, green and blue pixel circuits 20R, 20G, and 20B through the data lines Xm.

As shown in FIG. 3, each of the pixel circuit 20 comprises a driving transistor Q1 as a second transistor, a switching transistor Q2 as a first transistor and a storage capacitor C1 as a storage element. The driving transistor Q1 is constructed with P channel transistor. The switching transistor Q2 is constructed with N channel transistor.

The drain of the driving transistor Q1 is connected to the anode of the organic EL element 21 and its source is connected to a power supply line VL for supplying driving voltage Vdd. The gate of the driving transistor Q1 is connected to the storage capacitor C1.

The other end of the storage capacitor C1 is connected to the power supply line VL. The gate of the switching transistor Q2 of the pixel circuit is connected to the corresponding one of the scanning lines Yn. In addition, the drain of the switching transistor Q2 is connected to one of the data lines Xm and its source is connected to the gate of the driving transistor Q1 and the storage capacitor C1.

As shown in FIG. 3, each of the single line driving circuits 30 comprises a data voltage generating circuit 30a and a reset voltage generating circuit 30b. Each of the data voltage generating circuit 30a supplies data signal VD to the pixel circuit 20 connected to a corresponding data line Xm through first switche Q11. Generally, the data signals VD generated by the data voltage generating circuit 30a may have binary value or digital value, but in the present invention, the data signals are multi-valued and the 64 voltage levels.

The reset voltage generating circuits 30b supply reset voltages Vr as reset control signals to the pixel circuits 20 connected to the corresponding data lines Xm through second switches Q12. The reset control signals are signals for stopping the supplication of current to the organic EL elements 21 but they are not particularly limited thereto. Here, the reset voltages Vr are set to voltages for setting charge quantities which should be held to the storage capacitors C1 in order to make conduction states of the driving transistors Q1 be in substantial OFF states.

Specifically, in the case that the driving transistor is a P channel transistor similar to the present invention, it is sufficient that the reset voltage Vr is a voltage having the value or more that is a source potential Vdd of the driving transistor Q1 subtracted by a threshold voltage Vth of the driving transistor Q1, and in the present invention, the reset voltage Vr is set to be equal to the driving voltage Vdd applied to the power supply line VL.

In addition, in the case that the driving transistor Q1 is a N channel transistor, if the reset voltage Vr which is a voltage having the value or less that the source potential of the driving transistor Q1 added by the threshold voltage Vth of the driving transistor Q1, the driving transistor Q1 is in substantial OFF state.

The first switch Q11 is constructed with a N channel transistor and its conduction state is controlled by the a first gate signal G1. The second switch Q12 is constructed with a P channel transistor and its conduction state is controlled by a second gate signal G2. Therefore, it is possible to apply any one of the data signal VD and the reset voltage Vr to each of the data lines Xm by controlling the conduction of each of the first and second switches Q11, Q12.

The scanning line driving circuit 13 appropriately selects one of the scanning lines Yn, thereby selecting a pixel circuit group for one row. The scanning line driving circuit 13 comprises a decoder circuit in the present embodiment, so that one of the scanning lines Yn can be appropriately selected based on address signals ADn from the control circuit 17 and a scan signal SC1 (Yn) corresponding to the one scanning line can be output. In other words, it is possible to sequentially select the scanning lines Yn from the top portion in accordance with the address signals ADn sequentially output from the control circuit 17, and also it is possible to select optionally the scanning lines Yn (for example, in every other scanning line).

In addition, when the switching transistor Q2 of the pixel circuit 20 on the scanning line selected in accordance with the scan signal SC1 (Yn) which turns ON the switching transistor Q2, the data signal VD or the reset voltage Vr is supplied to the storage capacitor C1 through the corresponding data line of the data lines Xm in the conduction States of the first and second switches Q11, Q12.

The memory 14 stores the display data applied from the computer 18. The oscillating circuit 15 supplies a reference operating signal to the other components of the organic EL display 10. The power supply circuit 16 supplies driving power of each of the components of the organic EL display 10.

The control circuit 17 wholly controls each of the components 11 to 16. The control circuit 17 converts the display data (image data) stored at the memory 14 for indicating the display states of the display panel portion 11 into matrix data for indicating the light emitting gradations of each of the organic EL elements 21. The matrix data comprises the address signals ADn for designating the scanning line outputting the scan signal SC1 (Yn) in order to select a pixel circuit group for one row and the data signal generating driving signals for setting the data signals VD in order to set the luminescence of the organic EL elements 21 in the selected pixel circuit group. In addition, the address signals ADn is supplied to the scanning line driving circuit 13. Furthermore, the data signal generating driving signals are applied to the data line driving circuit 12.

In addition, the control circuit 17 previously sets the selection sequence of the scanning lines for writing (setting) of the data signal VD and writing (resetting) of the reset voltage Vr to the pixel circuit 20 based on the display data stored at the memory 14 by selecting the scanning lines.

In addition, the control circuit 17 carries out driving timing control of the scanning lines Yn and data lines Xm, and at the same time, outputs the gate signals G1, G2 for carrying out the conduction control of the first and second switches Q11, Q12 of the single line driving circuit 30.

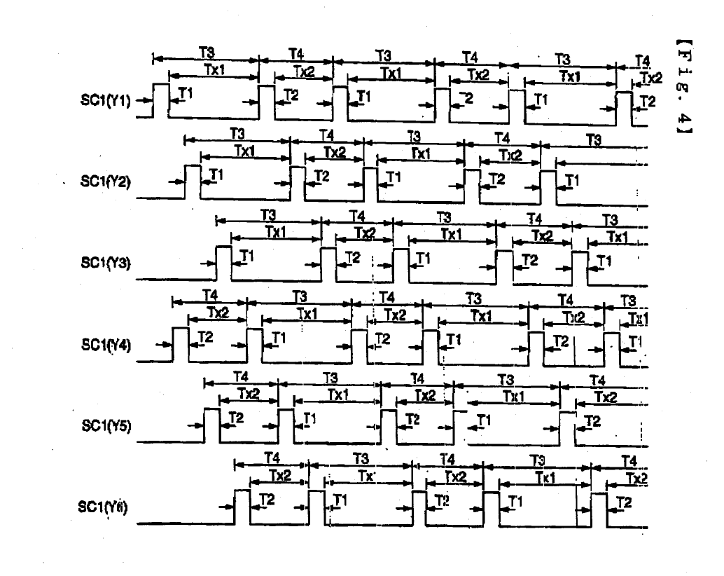

Next, the functions of the organic EL display 10 constructed as described above will be described in accordance with the selecting operations of the scanning lines and the driving operations of the data lines of the control circuit 17. In addition, for easy description, an exemplary organic EL display 10 comprising six scanning lines (Y1 to Y6) will be described. FIG. 4 is a timing chart of the scanning signals SC1 (Y1 to Y6) output to the six scanning lines Y1 to Y6.

Now, the operation of the one scanning line of the scanning lines Y1 to Y6 will be described. In a set time interval T1 set by the scanning signals SC1 (Y1 to Y6), a data signal VD is written in the pixel circuit 20 disposed corresponding to the selected scanning line. After the set time interval T1 and predetermined time Tx1, the reset voltage Vr is written in the pixel circuit 20 corresponding to the scanning line selected in the reset time interval T2 set by the scanning signals SC1 (Y1 to Y6). After the reset time interval T2 and predetermined Tx2, the aforementioned set time interval T1 arrives and the red, green and blue data signals VD are written in the pixel circuit 20. After that, the same selections are repeated and the pixel circuits are driven.

In the scanning lines Y1 to Y6, there are the scanning lines (for example, the scanning line Y1) which are started from the set time interval T1 and the scanning lines (for example, the scanning line Y4) which are started from the reset time interval T2. In other words, the reset time interval T2 may be performed before the set time interval T1 in order to write new data, and the scanning lines for writing (setting) the data signals VD and the scanning lines for writing (resetting) the reset voltages Vr are alternately selected in time. In addition, in the timing chart of FIG. 4, at the time of selecting the scanning lines, the selecting sequence is set to select the scanning line selected before one scanning line and the scanning line other than the adjacent to scanning lines.

In addition, as shown in FIG. 4, the control circuit 17 selects the scanning lines for setting or resetting in the selecting sequence of scanning line Y1 (setting)→scanning line Y4 (resetting)→scanning line Y2 (setting)→scanning line Y5 (resetting)→scanning line Y3 (setting)→scanning line Y6 (resetting)→scanning line Y4 (setting)→scanning line Y1 (resetting)→scanning line Y5 (setting)→scanning line Y2 (resetting)→scanning line Y6 (setting)→scanning line Y3 (resetting), and output address signals ADn to the scanning line driving circuit 13 to repeat the setting sequence.

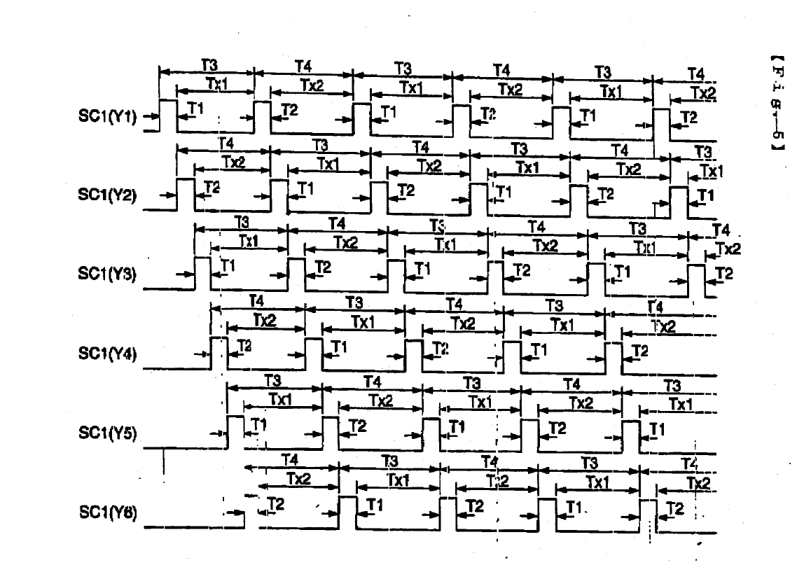

On the other hand, as shown in FIG. 5, the scanning lines for setting or resetting may be selected in the selecting sequence of scanning line Y1 (setting)→scanning line Y2 (resetting)→scanning line Y3 (setting)→scanning line Y4 (resetting)→scanning line Y5 (setting)→scanning line Y6 (resetting)→scanning line Y1 (resetting)→scanning line Y2 (setting)→scanning line Y3 (resetting)→scanning line Y4 (setting)→scanning line Y5 (resetting)→scanning line Y6 (setting).

In other words, any one side of the even numbered scanning lines and the odd numbered scanning lines is selected in order to write data, the other side is selected in order to apply a reset control signal, and at the same time, the writing of data and the application of reset control signals are alternately performed in time.

In addition, it is preferable that any one side of the even numbered scanning lines and the odd numbered scanning lines be selected in order to consecutively perform the writing of the data, and then the other side of the even numbered scanning lines and the odd numbered scanning lines is consecutively applied with the reset control signals. In this case, there are some problems that the writing of the data is concentrated in time for a short time scale, but it is possible to use the time interval for supplying the reset control signals as a data preparation time interval for writing the next data. In short, by alternately repeating the writing of the data and the resetting for any repeating units, it is possible to use the time interval for performing the resetting or the time interval in which the pixel circuit holds a reset state as the time interval for preparing the data signals applied through the data lines.

Next, the operation of the pixel circuit 20 of the selected scanning line will be described.

First, under the state that the first gate signal G1 for turning ON the first switch Q11, the scan signals SC1 (Y1 to Yn) for turning ON the switching transistor Q2 are applied through the scanning line Yn in the set time interval T1, thereby turning ON the corresponding switch transistor Q2. At this time, the data signal VD is supplied to the storage capacitor C1 through the data lines X1 to Xm and the switching transistor Q2.

By doing so, the storage capacitor C1 is held with the charge quantity corresponding to the data signal VD. A voltage according to the charge quantity is applied as a gate voltage to the driving transistor Q1, thereby setting the conduction states of the driving transistor Q1. A current having current levels according to the conduction states passes through the driving transistor Q1, and the current is supplied to organic EL element 21 as a driving current of the organic EL element 21, thereby starting light emitting of the organic EL element 21.

After the set time interval T1, although the switching transistor Q2 is in OFF state, since the charge quantity set by the data signal VD is held on the storage capacitor C1, the application of the driving current is not stopped over the organic EL element 21.

After the light emitting time interval T3, the first switch Q11 and the second switch Q12 are in OFF and ON states, respectively, and in turn, the scan signals SC1 (1 to Yn) for turning ON the switching transistor Q2 are output, thereby the reset voltage Vr is applied from the reset voltage generating circuit to the storage capacitor C1 through the data lines Xm and the switching transistor Q2.

Next, after the reset time interval T2, the switching transistor Q2 is in OFF state, the state of stopping the application of the driving current to the organic EL element 21 is held in the time interval Tx2, and then the start of the next set time interval T1 waits.

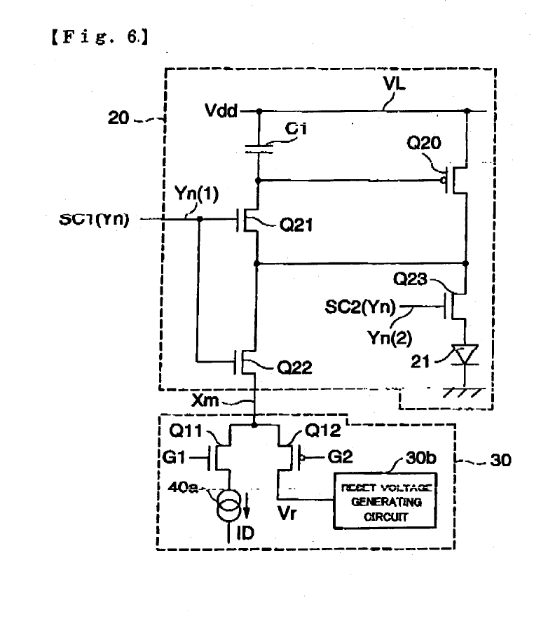

The pixel circuit shown in FIG. 6 is employed in place of the pixel circuit shown in FIG. 3.

The pixel circuit 20 shown in FIG. 6 comprises a driving transistor Q20 as a second transistor, a switching transistor Q22 as a first transistor, a light emitting interval control transistor Q23, a switching transistor Q21 for controlling electrical connections of the drain and gate the driving transistor Q20, and the storage capacitor C1 as a hole element. The driving transistor Q20 is constructed with P channel transistor. The switching transistors Q21, Q22 and light emitting interval control transistor Q23 are constructed with N channel transistors.

The drain of the driving transistor Q20 is connected to the anode of the organic EL element 21 through the light emitting interval control transistor Q23 and its source is connected to the power supply line VL. The driving voltage Vdd for driving the organic EL element 21 is supplied to the power supply line VL. The storage capacitor C1 is connected between the gate of the driving transistor Q20 and the power supply line VL.

In addition, the gate of the driving transistor Q20 is connected to the drain of the switching transistor Q21. The source of the switching transistor Q21 is connected to the drain of the switching transistor Q22. In addition, the drain of the switching transistor Q22 is connected to the drain of the driving transistor Q20.

In addition, the source of the second switching transistor Q22 is connected to the single line driving circuit 30 of the data line driving circuit 12 through data lines Xm. Furthermore, a data current generating circuit 40a is provided to the single line driving circuit 30. The data current generating circuit 40a outputs a data signal ID as a multi-valued data signal to each of the pixel circuit 20. The data signal ID is a current signal. The data lines Xm are connected to the data current generating circuit 40a through the first switch Q11. In addition, the data lines Xm are also connected to the reset voltage generating circuit 30b through the second switch Q12.

Therefore, when the first switch Q11 is turned ON, the data signal ID is supplied to each of the pixel circuit 20 through the data lines Xm. In addition, when the second switch Q12 is turned ON, the reset voltage Vr is supplied to each of the pixel circuit 20 through the data lines Xm.

In addition, the first scanning lines Yn (1) is connected to the gates of the switching transistors Q21, Q22, and the switching transistors Q21, Q22 are controlled by the first scan signal SC1 (Yn) applied from the first scanning line Yn (1). In addition, the second scanning line Yn (2) is connected to the gate of the light emitting interval control transistor Q23. Furthermore, the light emitting interval control transistor Q23 is controlled by the second scan signal SC2 (Yn) applied from the second scanning line Yn (2).

When the first scan signal SC1 (Yn) for turning ON the first switch Q1, turning OFF the second switch Q12, turning OFF the light emitting interval control transistor Q23, and turning ON the switching transistors Q21. Q22 is applied, the data line Xm and the switching transistors Q21, Q22 are electrically connected, and the data signal ID which is a current signal passes through the driving transistor Q20 and the switching transistor Q22. By doing so, charge quantity corresponding to the data signal ID is held at the storage capacitor C1, thereby setting the conduction state of the driving transistor Q20.

After setting the conduction of the driving transistor Q20, the switching transistors Q21, Q22 are turned OFF, thereby disconnecting the electrical connection of the data line Xm and the pixel circuits 20.

Subsequently, by supplying the second scan signal SC2 (Yn) for turning ON the light emitting interval control transistor Q23 to the gate of the light emitting interval control transistor Q23, the current level corresponding to the conduction states of the driving transistor Q20 is obtained and also the current passing through the driving transistor Q20 is supplied to the organic EL element 21 as a driving current of the organic EL element 21.

Next, by turning OFF the first switch Q11, turning ON the second switch Q12, and in turn, turning the switching transistors Q21, Q22, the reset voltage Vr from the reset voltage generating circuit 30b is supplied to the storage capacitor C1 through the switching transistors Q21, Q22. When the reset voltage Vr is set to be a voltage for substantially turning OFF the driving transistor Q20, the driving transistor Q20 is turned OFF. After turning OFF the driving transistor Q20, and in turn, turning OFF the switching transistors Q21n Q22, the timing for supplying the next data signal ID waits.

In addition, in the case that the driving transistor is a P channel transistor similar to the present invention, the reset voltage Vr may be a voltage having the value or more that is a source potential Vdd of the driving transistor Q1 subtracted by a threshold voltage Vth of the driving transistor Q1, and in the present invention, the reset voltage Vr is set to be equal to the driving voltage Vdd applied to the power supply line VL.

In other words, in the case that the driving transistor Q1 is a N channel transistor, if the reset voltage Vr which is a voltage having the value or less that the source potential of the driving transistor Q1 added by the threshold voltage Vth of the driving transistor Q1, the driving transistor Q1 is in substantial OFF state.

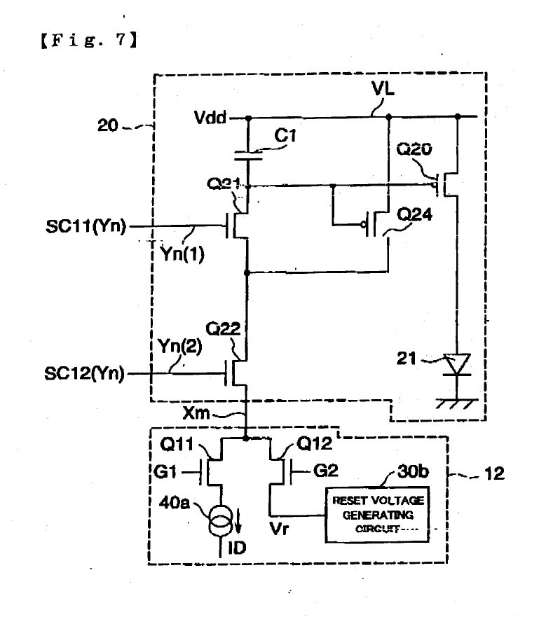

The pixel circuit shown in FIG. 7 is employed in place of the pixel circuit shown in FIG. 3.

In FIG. 7, the conduction states of the switching transistor Q21 are controlled by the scan signal SC11 (Yn). The conduction states of the switching transistor Q22 are controlled by the scan signal SC12 (Yn).

By turning ON the first switch Q11, turning OFF the second switch Q12, and turning ON the switching transistors Q21, Q22, the data lines Xm and the switching transistors Q21, Q22 are electrically connected, the data signal which is a current signal passes through the switching transistor Q22 and a complementary transistor Q24 of which gate is commonly connected to the storage capacitor C1 with the driving transistor Q20. By doing so, charge quantity corresponding to the data signal ID is held at the storage capacitor C1, thereby setting the conduction states of the driving transistor Q20.

After setting the conduction state of the driving transistor Q20, the switching transistors Q21, Q22 are turned OFF, thereby disconnecting the electrical connection of the data line Xm and the pixel circuits 20.

And then, the current level corresponding to the conduction states of the driving transistor Q20 is obtained and also the current passing through the driving transistor Q20 is supplied to the organic EL element 21 as a driving current of the organic EL element 21.

In addition, since the pixel circuit shown in FIG. 7 does not comprise the light emitting interval control transistor for controlling electrical connection of the driving transistor Q20 and the organic EL element 21 similar to the pixel circuit shown in FIG. 6, the termination of the setting of the conduction states of the driving transistor Q20 is not waited and the application of the driving current to the organic EL element 21 is started.

Next, by turning OFF the first switch Q11, turning ON the second switch Q12, and in turn turning ON the switching transistors Q21, Q22, the reset voltage Vr from the reset voltage generating circuit 30b is supplied to the storage capacitor C1 through the switching transistors Q21, Q22. When the reset voltage Vr is set to be a voltage for substantially turning OFF the driving transistor Q20, the driving transistor Q20 is turned OFF. After turning OFF the driving transistor Q20, and in turn, turning OFF the switching transistors Q21, Q22, the timing for supplying the next data signal ID waits.

In addition, in the case that the driving transistor is a P channel transistor similar to the present invention, the reset voltage Vr may be a voltage having the value or more that is a source potential Vdd of the driving transistor Q1 subtracted by a threshold voltage Vth of the driving transistor Q1, and in the present invention, the reset voltage Vr is set to be equal to the driving voltage Vdd applied to the power supply line VL.

In other words, in the case that the driving transistor Q1 is a N channel transistor, if the reset voltage Vr which is a voltage having the value or less that the source potential of the driving transistor Q1 added by the threshold voltage Vth of the driving transistor Q1, the driving transistor Q1 is in substantial OFF state.

Although the reset control signal is supplied to the pixel circuit through the data signal in addition to the data signal in the aforementioned embodiment, the reset control signal or reset voltage may be applied to the pixel circuit through the signal lines other than the data lines.

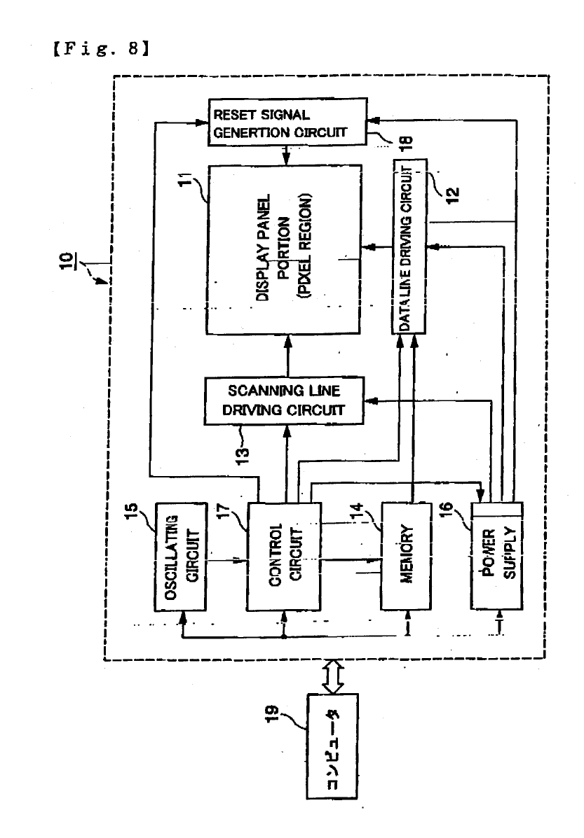

For example, similar to the construction shown in FIG. 8, there is an exemplary electronic device which comprises a reset control signal generating circuit 18 in addition to the display panel portion 11, data line driving circuit 12, the scanning line driving circuit 13, the memory 14, the oscillating circuit 15, the power supply circuit 16, and the control circuit 17.

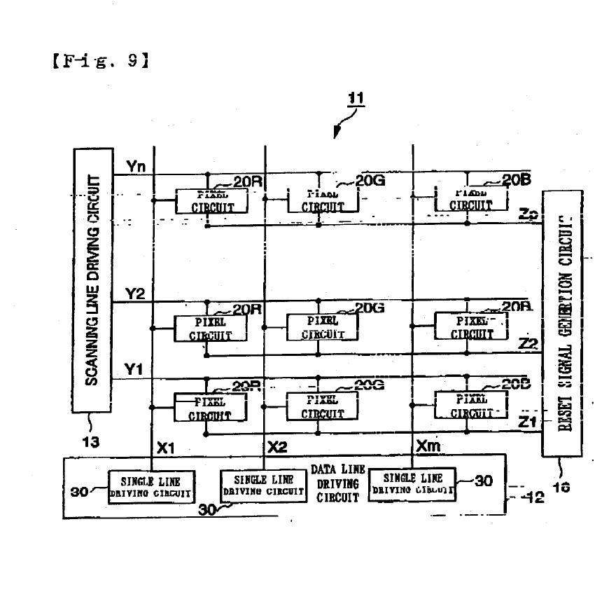

As shown in FIG. 9, in addition to the data lines Xm (m is a natural number) extending along the column direction and the scanning lines Yn (n is a natural number), as the second signal lines, extending along the row direction, voltage signal transmitting lines Zp (p is a natural number), which is disposed to each of the pixel circuits 20 in the direction interconnecting the data lines Xm and also is connected to the reset control signal generating circuit 18 is connected to the display panel portion 11. The reset voltages Vr from the reset control signal generating circuit 18 are applied to the corresponding pixel circuits 20 through the voltage signal transmitting lines Zp.

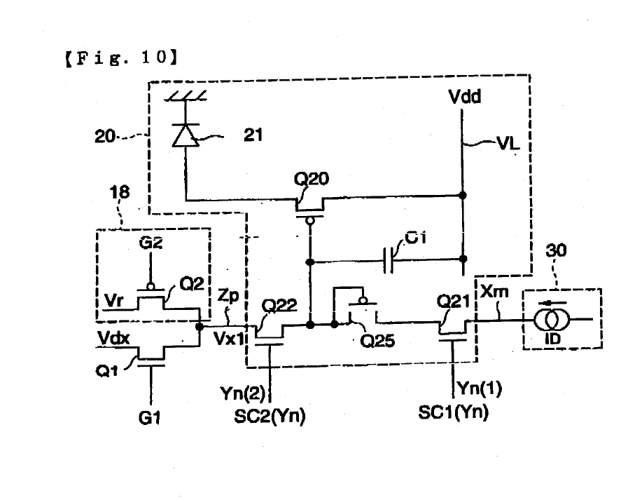

FIG. 10 illustrates an example of the pixel circuit suitable for the aforementioned construction.

The pixel circuits 20 are connected to the scanning lines Yn (1), Yn (2), the data lines Xm, and the voltage signal transmitting lines Zp. Each of the pixel circuits 20 comprises the driving transistor Q20 as a second transistor, the switching transistor Q21 as a first transistor, the storage capacitor C1 as a hole element, the switching transistor Q22 for controlling the electrical connection of the voltage signal transmitting lines Zp and the pixel circuit 20, and the complementary transistor Q25. The driving transistor Q20 and the complementary transistor Q25 are constructed with P channel transistors. The switching transistors Q21, Q22 are constructed with N channel transistors.

The drain of the driving transistor Q20 is connected to the pixel electrode of the organic EL element 21 and its source is connected to the power supply line VL. The driving voltage Vdd for driving the organic EL element 21 is supplied to the power supply line VL and the driving voltage Vdd is set to be a voltage value higher than the operating voltage Vdx. The storage capacitor C1 is connected between the gate of the driving transistor Q20 and the power supply line VL.

The gate of the driving transistor Q20 is connected to the source of the switching transistor Q21 through the complementary transistor Q25. In addition, the gate of the driving transistor Q20 is connected to the drain of the switching transistor Q22.

The scanning line Yn (1) is connected to the gate of the switching transistor Q21. In addition, the scanning line Yn (2) is connected to the gate of the switching transistor Q22.

The source of the switching transistor Q22 is connected to the reset signal generating circuit 18, the first switch Q1 and the second switch Q2 through the voltage signal transmitting lines Zp. The drain of the switching transistor Q21 is connected to the single line driving circuit 30 through the data lines Xm.

Therefore, when the scan signal SC1 (Yn) and the scan signal SC2 (Yn) for turning ON the switching transistor Q21 and the switching transistor Q22, respectively, are applied to turn ON the first switch Q1, the data signal ID which is an current signal flows via the switching transistors Q21, Q22, the complementary transistor Q25 and the first switch Q1, and then the charge quantity corresponding to the data signal ID is held on the storage capacitor C1, thereby setting the conduction states of the driving transistor Q20.

Next, By turning OFF the switching transistor Q21 and the switching transistor Q22 are turned OFF and holding the charge quantity corresponding to the data signal ID held on the storage capacitor C1, the current having the current levels according to the conduction states of the driving transistor Q20 is supplied to the organic EL element 21 as a driving current.

The reset operations are carried out by turning OFF the switching transistor Q21 and the first switch Q1 and turning ON the switching transistor Q22 and the second switch Q2. By doing so, the reset voltage Vr is supplied to the storage capacitor C1 through the switching transistor Q22, thereby setting the driving transistor Q20 in OFF state.

The pixel circuit shown in FIG. 10 may be also operated in accordance with the timing charts shown in FIGS. 4 and 5. In this case, it is preferable that the switching transistor Q21 and the switching transistor Q22 be turned ON in the only set time interval T1 and the switching transistor Q22 is turned ON in the reset time interval T2, so that the voltage signal transmitting lines Zp and the pixel circuit 20 can be electrically connected.

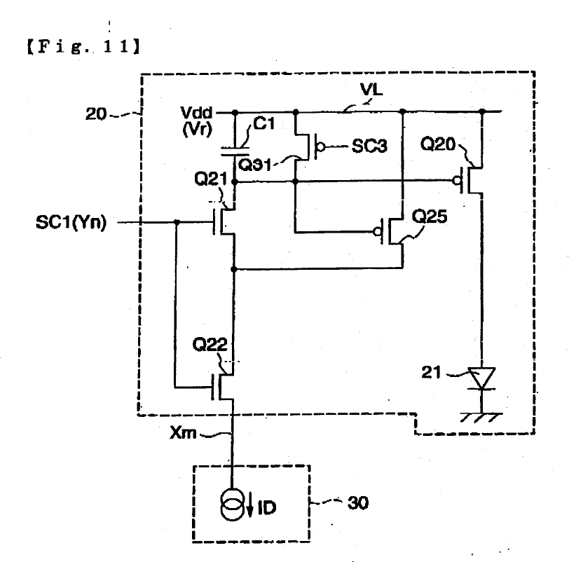

In addition, as shown in FIG. 11, the pixel circuit having a reset transistor Q31 in addition to the pixel circuit shown in FIG. 7 may be employed. In the pixel circuit shown in FIG. 11, the reset voltage Vr and the driving voltage Vdd are shared, and therefore it is unnecessary to particularly provide a circuit for generating the reset voltage Vr.

By turning ON the reset transistor Q31, the driving voltage Vdd is supplied to the gate of the driving transistor Q20 and the charge quantity corresponding to the driving voltage Vdd is held on the storage capacitor C1, so that the driving transistor Q20 is turned OFF.

In this state, if the reset transistor Q31 is turned OFF, the OFF state of the driving transistor Q20 is held until the writing of the next data signal ID.

Of course, at the time of the writing of the data signal ID, the reset transistor Q31 is set to be in the OFF state.

The pixel circuit shown in FIG. 11 may be also operated in accordance with the timing charts shown in FIGS. 4 and 5. In this case, it is preferable that the switching transistor Q21 and the switching transistor Q22 be turned ON in the only set time interval T1 and the switching transistor Q31 is turned ON in the reset time interval T2, so that the driving voltage Vdd and the driving transistor Q20 can be electrically connected.

In addition, the other constructions may be employed. In the pixel circuit shown in FIG. 6, by turning OFF the light emitting interval control transistor Q23, the organic EL element 21 may be reset.

The pixel circuit may be also operated in accordance with the timing charts shown in FIGS. 4 and 5. In this case, it is preferable that the switching transistor Q21 and the switching transistor Q22 be turned ON in the only set time interval T1 and the light emitting interval control transistor Q23 be turned OFF in the reset time interval T2, so that the electrical connections of the driving transistor Q20 and the organic EL element 21 can be disconnected.

In addition, since the reset operation can be carried out only by the conduction control of the light emitting interval control transistor Q23, it is unnecessary to particularly provide the reset voltage generating circuit 30b, but it is probable to provide it in the case wherein the charge quantity of the storage capacitor C1 or the data line is need to be reset.

In the aforementioned embodiment, if the time interval from the time writing of a data signal in a pixel circuit starts to the time subsequently writing of a data signal in a pixel circuit starts is defined as an one frame, a reset operation is carried out over any one pixel circuit within the one frame, so that it is possible to use the time interval in which the reset operation is carried out as a preparation time for generating or supplying a next data signal. By doing so, it is possible to reduce loads of the data line driving circuit for driving data lines or a circuit for supplying reset control signals.

In addition, in a case wherein all of the data signals are serially applied to pixel circuits disposed on the panel from a data line driving circuit embedded in an externally mounted IC, the external terminals for transmitting the data signals to the panel from the externally mounted IC must be disposed to correspond to the number of data lines above the panel. However, the time interval in which the reset operation is carried out can be used as the time interval in which the serial transmission of the data signal is carried out, so that it is possible to reduce the number of the external terminals.

Particularly, since the pixel circuits shown in FIGS. 6, 7, 10 and 11 which the current signals are applied as data signals need to ensure time enough to carry out the serial transmission of the data signals, the aforementioned effect is more dominating.

In addition, the aforementioned embodiment may be modified as follows.

∘ In the aforementioned embodiment, all the pixel circuits 20R, 20G, 20B on the selected scanning lines was simultaneously set or reset. In other words, as shown in FIG. 4, all the pixel circuits 20R, 20G, 20B was set or reset in one cycle of scanning line Y1 (setting)→scanning line Y4 (resetting)→scanning line Y2 (setting)→scanning line Y5 (resetting)→scanning line Y3 (setting)→scanning line Y6 (resetting)→scanning line Y4 (setting)→scanning line Y1 (resetting)→scanning line Y5 (setting)→scanning line Y2 (resetting)→scanning line Y6 (setting)→scanning line Y3 (resetting).

With three cycles thereof, all the pixel circuits 20R, 20G, 20B may be set or reset by separately controlling each of the pixel circuits 20R, 20G, 20B of every color. In this case, in FIG. 4, the red pixel circuit 20R in each of the scanning lines Y1 to Y6 is set or reset in the first cycle. The green pixel circuit 20G in each of the scanning lines Y1 to Y6 is set or reset in the second cycle. The blue pixel circuit 20B in each of the scanning lines Y1 to Y6 is set or reset in the third cycle.

By doing so, it is possible to adjust the light emitting time interval of each of the pixel circuit corresponding to the each color.

Furthermore, the principle of the present invention can be employed in the below mentioned construction.

Although the aforementioned embodiment is implemented with the pixel circuit 20 as electronic circuit to have appropriate effects, it may be implemented with electronic circuits having various electro-optical elements such as, for example, LEDs, FEDs, inorganic EL elements, liquid crystal elements, electron emitting elements, or plasma light emitting elements besides the organic EL element 21. It may be implemented with storage devices such as RAM.

Although the present invention is adapted to the electro-optical apparatus driven by a driving method using analog data signal in aforementioned embodiment, the present invention may be also adapted to an electro-optical apparatus driven by a digital driving method such as time division gradation method, or area gradation method.

Although one voltage is used as the reset voltage Vr in the aforementioned embodiment, a plurality of voltages may be used as the reset voltages Vr.

Although the reset voltage Vr is used as reset control signal in the aforementioned embodiment, a current signal may be used.

Although the organic EL display is the one that the pixel circuits 20R, 20G, 20B for each color are disposed to three color organic EL elements 21 in the aforementioned embodiment, the present invention may be adapted to EL displays constructed with pixel circuits having EL elements having one color, two colors, or four colors or more.

### COMPARATIVE EXAMPLES

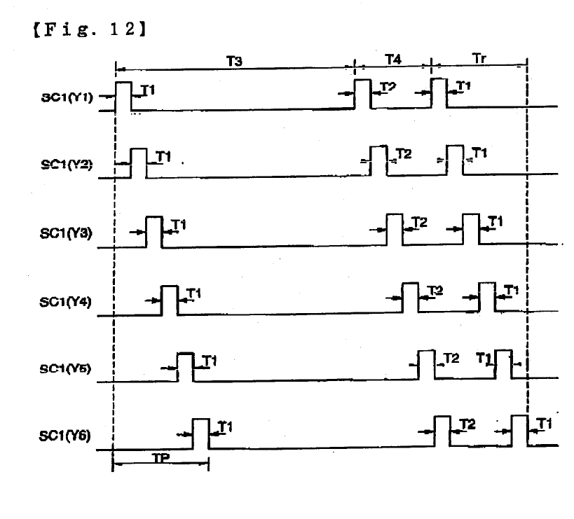

In addition, for comparison with the aforementioned embodiment, the case that the writing of the data is firstly carried out over all the pixel circuits and then the resetting is carried out in the electro-optical apparatus comprising the pixel circuits shown in FIG. 12 will be described.

FIG. 12 is a timing chart illustrating light emitting time intervals and reset time intervals in each of the scanning lines in the screen display. Y1 to Yn (n is an integer and n=6 in this figure for convenience of description) denote each of the scanning lines, respectively. T1 denotes a set time interval (the time interval for inputting a data signal to each of the pixel circuits) and T2 denotes a reset time interval. Therefore, each of the scanning lines Y1 to Y6 is selected at a scanning line driving circuit in the set time interval T1 and the reset time interval T2. In addition, data signals are applied to the pixel circuits connected to the selected scanning lines in the set time interval T1. In addition, the reset voltages from a reset voltage generating circuit are applied to the pixel circuits connected to the selected scanning lines in the reset time interval T2. Therefore, a light emitting time interval T3 starts from the start of the set time interval T1 to the start of the reset time interval T2.

As shown in FIG. 12, the scanning lines are selected from the scanning lines Y1 to Y6 one by one in the scanning line driving circuit, data signals are written in each of the pixel circuits on the selected scanning lines during the selection time interval (set time interval T1). At that time, the data signals are written, so that the organic EL elements of the pixel circuits emit light with luminescence corresponding to the data signals. Next, when the writing of the data signals up to the scanning line Y6 are completed (in other words, the writing of the one frame is completed), the scanning line driving circuit selects subsequently the scanning lines from the scanning lines Y1 to Y6 one by one, and the reset voltages are written in each of the pixel circuits on the selected scanning lines during the selection time interval (reset time interval T2). At that time, the reset voltages are written, so that the organic EL elements of the pixel circuits have luminescence of zero. Under the state, the writing of the next data signal waits.

However, as apparently noted from FIG. 12, since the scanning lines Y1 to Y6 are selected one by one from the scanning line Y1 to the scanning line Y6, the set time intervals T1 of each of the scanning lines Y1 to Y6 are concentrated on a short time interval Tp. Moreover, similar thereto, the reset time intervals of each of the scanning lines Y1 to Y6 are also concentrated on a short time interval Transistor. For these reason, in aforementioned embodiment, the reset operation is carried out over any one of the pixel circuits before the data signals are applied to all the pixel circuit. By doing so, it is possible to alleviate the concentration of the time intervals in which the writing of the data signals is carried out.

[Second Embodiment]

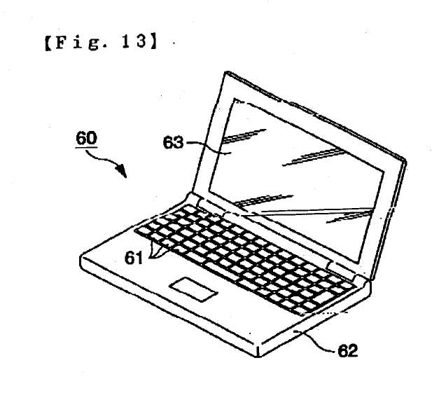

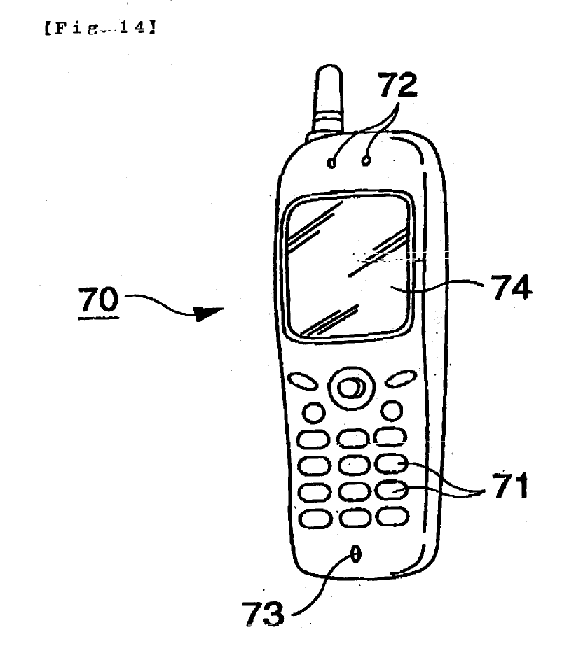

Next, the application of the electronic apparatus of the organic EL display 10 which is the electronic device described in the first embodiment will be described with reference to FIGS. 13 and 14. The organic EL display 10 is able to be applied to various electronic apparatuses such as portable type personal computers, mobile phones, digital cameras.

FIG. 13 is a perspective view illustrating a construction of a portable type personal computer. In FIG. 13, the personal computer 60 comprises a main body 62 having a keyboard 61 and a display unit 63 using the aforementioned organic EL display 10. In this case, the display unit 63 using the organic EL display 10 has the same effects as the aforementioned embodiment. As a result, it is possible for the personal computer 60 to implement image display without any defect.

FIG. 14 is a perspective view illustrating a construction of a mobile phone. In FIG. 14, the mobile phone comprises a plurality of manipulating buttons 71, a receiver portion 72, a transmitting portion 73, and a display unit 74 using the organic EL display 10. In this case, the display unit 74 using the organic EL display 10 has the same effects as the aforementioned embodiment. As a result, it is possible for the mobile phone 70 to implement image display without any defect.

What is claimed is:

1. An electronic device comprising:
a plurality of unit circuits disposed corresponding to intersections of a plurality of scanning lines and a plurality of data lines, each unit circuit comprising electronic elements; and
a control circuit for generating reset control signals to carry out reset operations of resetting to predetermined states the electronic elements which are included in at least one unit circuit among the plurality of unit circuits,
wherein output of the data signals to the plurality of data lines and the reset operations are alternately carried out.

2. An electronic device comprising:
a plurality of unit circuits disposed corresponding to intersections of a plurality of scanning lines and a plurality of data lines, each unit circuit comprising electronic elements, data signals and reset control signals for resetting the electronic elements to predetermined states being supplied to the plurality of unit circuits; and
a scanning line driving circuit for selecting a scanning line from the plurality of scanning lines in accordance with the supplied data signals,
wherein the scanning line driving circuit supplies scanning signals to the plurality of scanning lines so that a first scanning line which is selected from the plurality of scanning lines in order to apply the data signal to a first unit circuit among the plurality of unit circuits is not adjacent to a second scanning line which is selected from the plurality of scanning lines in order to subsequently supply the data signal to a second unit circuit among the plurality of unit circuits other than the first unit circuit; and
wherein during the time interval from the time that the data signal is supplied to the first unit circuit to the time that the data signal is supplied to the second unit circuit, the reset control signal is supplied to a third unit circuit other than the first unit circuit and the second unit circuit.

3. The electronic device according to claim 2, wherein among the plurality of scanning lines, a third scanning line corresponding to the third unit circuit is adjacent to the first scanning line and the second scanning line.

4. An electronic device comprising:
a plurality of unit circuits disposed corresponding to intersections of a plurality of scanning lines and a plurality of data lines, each unit circuit comprising electronic elements, data signals and reset control signals for resetting the electronic elements to predetermined states being supplied to the plurality of unit circuits; and
a scanning line driving circuit for selecting a scanning line from the plurality of scanning lines in accordance with the supplied data signals,
wherein the scanning line driving circuit supplies scanning signals to the plurality of scanning lines so that a first scanning line which is selected from the plurality of scanning lines in order to apply the data signal to a first unit circuit among the plurality of unit circuits is adjacent to a second scanning line which is selected from the plurality of scanning lines in order to subsequently supply the data signal to a second unit circuit among the plurality of unit circuits other than the first unit circuit; and
wherein during the time interval from the time that the data signal is supplied to the first unit circuit to the time that the data signal is supplied to the second unit circuit, the reset control signal is supplied to a third unit circuit other than the first unit circuit and the second unit circuit.

5. The electronic device according to claim 4, wherein a third scanning line corresponding to the third unit circuit among the plurality of scanning lines is not adjacent to the first scanning line and the second scanning line.

6. An electronic device comprising:
a plurality of unit circuits disposed corresponding to intersections of a plurality of scanning lines and a plurality of data lines, each unit circuit comprising electronic elements, data signals and reset control signals for resetting the electronic elements to predetermined states being supplied to the plurality of unit circuits; and
a scanning line driving circuit for selecting a scanning line from the plurality of scanning lines in accordance with the supplied data signals,
wherein the scanning line driving circuit alternately selects scanning lines for supplying the data signals thereto and scanning lines for supplying the reset control signals thereto.

7. An electronic device comprising:
a plurality of unit circuits disposed corresponding to intersections of a plurality of scanning lines and a plurality of data lines, each unit circuit comprising a first transistor which is controlled by a scan signal applied through the corresponding scanning line among the plurality of scanning lines, a storage element for holding a data signal applied through the first transistor, a second transistor whose conduction state is set in accordance with the data signals held at the storage element, and electronic elements having applied thereto voltages or currents having voltage levels or current levels in accordance with the conduction state of the set second transistor;
a data line driving circuit for outputting the data signals to the plurality of data lines; and
a scanning line driving circuit for supplying the scan signals to the plurality of unit circuits,
wherein during the time interval from the time that the data signal is supplied to a first unit circuit among the plurality of unit circuits to the time that the data signal is supplied to a second unit circuit other than the first unit circuit, a reset control signal for substantially turning off the second transistor in the storage element is supplied to a third unit circuit other than the first unit circuit and the second unit circuit through the corresponding data line among the plurality of data lines.

8. The electronic device according to claim 7, wherein the first scanning line of the plurality of scanning lines, corresponding to the first unit circuit is adjacent to the second scanning line, of the plurality of scanning lines, corresponding to the second unit circuit, and
wherein a third scanning line of the plurality of scanning lines, corresponding to the third unit circuit is not adjacent to the first scanning line and the second scanning line.

9. An electronic device according to claim 7, wherein the first scanning line, of the plurality of scanning lines, corresponding to the first unit circuit is adjacent to the third scanning line, of the plurality of scanning lines, corresponding to the third unit circuit, and
wherein the second scanning line, of the plurality of scanning lines, corresponding to the second unit circuit is not adjacent to the first scanning line, of the plurality of scanning lines, corresponding to the first unit circuit.

10. The electronic device according to claim 8, wherein when the reset control signal is supplied to the third unit circuit, the third scanning line is selected and the reset control signal is supplied to the storage element through the first transistor of the third unit circuit.

11. The electronic device according to claim 1, wherein the data signals are multi-valued.

12. The electronic device according to claim 1, wherein current signals are applied as the data signals.

13. The electronic device according to claim 1, wherein the electronic elements are EL elements.

14. The electronic device according to claim 13, wherein the EL elements comprise light emitting layers which are made of organic materials.

15. A method of driving an electronic device comprising a plurality of unit circuits disposed corresponding to intersections of a plurality of scanning lines and a plurality of data lines, each unit circuit comprising electronic elements, the method comprising the steps of:
supplying a data signal to a first unit circuit among the plurality of unit circuits through the corresponding data line among the plurality of data lines;
supplying a reset control signal for resetting to predetermined states the electronic elements which are included in a third unit circuit, other than the first unit circuit and the second unit circuit, among the plurality of unit circuits; and
supplying a data signal to a second unit circuit other than the first unit circuit among the plurality of unit circuits through the corresponding data line among the plurality of data lines.

16. The method of driving an electronic device according to claim 15, wherein a scanning line which is selected from the plurality of scanning lines in order to apply the data signal to the first unit circuit is adjacent to the scanning line corresponding to the third unit circuit among the plurality of scanning lines.

17. A method of driving an electronic device comprising a plurality of unit circuits disposed corresponding to intersections of a plurality of scanning lines and a plurality of data lines, each unit circuit comprising electronic elements, the method comprising the steps of:
selecting one scanning line from the plurality of scanning lines in order to apply a data signal to a first unit circuit among the plurality of unit circuits;
selecting a scanning line which is not adjacent to the one scanning line which is selected to apply the data signal to the first unit circuit in order to apply the data signal to a second unit circuit other than the first unit circuit; and
supplying a reset control signal to a third unit circuit other than the first unit circuit and the second unit circuit in order to reset the electronic elements which are included in the third unit circuit during the time interval from the time that the data signal is applied to the first unit circuit to the time that the data signal is applied to the second unit circuit.

18. A method of driving an electronic device comprising a plurality of unit circuits disposed corresponding to intersections of a plurality of scanning lines and a plurality of data lines, each unit circuit comprising electronic elements, the method comprising the steps of:
selecting one scanning line from the plurality of scanning lines, and supplying data signals from the corresponding data lines to each of the unit circuits corresponding to the selected scanning line; and
supplying reset control signals to unit circuits which are disposed to correspond to at least one scanning line among scanning lines other than the scanning lines adjacent to the selected scanning line in order to reset the electronic elements which are included in the unit circuits to predetermined states.

19. A method of driving an electronic device comprising a plurality of unit circuits disposed corresponding to intersections of a plurality of scanning lines and a plurality of data lines, each unit circuit comprising electronic elements, the method comprising the steps of:
selecting one scanning line from the plurality of scanning lines, and supplying data signals from the corresponding data lines to each of the unit circuits corresponding to the selected scanning line; and
selecting at least one scanning line among the scanning lines other than the selected scanning line, and supplying reset control signals to unit circuits corresponding to the at least one selected scanning line through corresponding data lines of the plurality of data lines in order to reset the electronic elements to predetermined states.

20. A method of driving an electronic device comprising a plurality of unit circuits disposed corresponding to intersections of a plurality of scanning lines and a plurality of data lines, each unit circuit comprising electronic elements, the method comprising a step of supplying reset control signals to at least one unit circuit among the plurality of unit circuits in order to reset the electronic elements to predetermined states during the time interval from the time that writing of data signals to the unit circuits starts to the time that subsequent writing of data signals to the unit circuits starts.

21. A method of driving an electronic device comprising a plurality of unit circuits disposed corresponding to intersections of a plurality of scanning lines and a plurality of data lines, each unit circuit comprising electronic elements, the method comprising the step of:
supplying, during the time interval from the time that writing of data signal to a unit circuit starts to the time that subsequent writing of data signals to the unit circuit starts, reset control signals to at least one unit circuit other than the unit circuit among the plurality of unit circuits in order to reset the electronic elements to predetermined states.

22. The method of driving an electronic device according to claim 15, wherein multi-valued or analog signals are applied as the data signals.

23. The method of driving an electronic device according to claim 15 wherein current signals are applied as the data signals.

24. The method of driving an electronic device according to claim 15, wherein each of the plurality of unit circuits comprises:
a first transistor which is controlled by a scan signal applied through the corresponding scanning line among the plurality of scanning lines;
a storage element for holding the data signal and the reset control signal applied through the first transistor as an electrical quantity corresponding thereto; and
a second transistor whose conduction state is set in accordance with the electrical quantity held at the storage element, the second transistor supplying to the electronic elements a voltage or current having a voltage level or current level corresponding to the conduction state,
wherein the reset control signal is supplied to the storage element to substantially turn off the conduction state of the second transistor, thereby to stop supplying voltage or current to the electronic elements.

25. The method of driving an electronic device according to claim 15, wherein the electronic elements are EL electronic elements.

26. An electronic apparatus comprising an electronic device according to claim 1.
